(19) United States
(12) Patent Application Publication
(10) Pub. No.: US 2021/0095513 A1
(43) Pub. Date: Apr. 1, 2021

(54) AUTOMATIC DOOR FOR A DOMESTIC APPLIANCE

(71) Applicant: ELECTROLUX APPLIANCES AKTIEBOLAG, Stockholm (SE)

(72) Inventors: Branko IVANOVIC, Rothenburg ob der Tauber (DE); Dietmar HILDNER, Rothenburg ob der Tauber (DE); Rudolf SCHMIDT, Rothenburg ob der Tauber (DE)

(21) Appl. No.: 17/044,441

(22) PCT Filed: Apr. 12, 2019
(86) PCT No.: PCT/EP2019/059386

§ 371 Date: Oct. 1, 2020

(30) Foreign Application Priority Data
Apr. 12, 2018 (EP) 18167054.8

(51) Int. Cl. E05F 15/611; F24C 7/08; F24C 15/02; E05F 15/40

(52) U.S. Cl. CPC E05F 15/611; F24C 7/085; E05Y 2900/308; E05F 15/40; F24C 15/024

(57) ABSTRACT

The present invention relates to an automatic door (12) for a domestic appliance (10), in particular an automatic oven door (12) for a cooking oven (10). The door (12) comprises at least one door handle (16) for manually opening and/or closing said door (12). The door (12) comprises at least one switch element (20) for automatically opening and/or closing said door (12).

The present invention relates to an automatic door for a domestic appliance. In particular, the present invention relates to an automatic oven door for a cooking oven. Further, present invention relates to a domestic appliance, in particular a cooking oven.

A door of a conventional domestic appliance may be opened and closed by manual gripping a door handle attached at said door. In contrast, an automatic door is opened and closed by a drive unit, wherein said automatic door usually does have any door handle, so that the user cannot manually open and close said automatic door. Further, the automatic door requires a reliable control of the opening angle and the opening and closing speed of said automatic door. Usually, the sensors for detecting the opening angle and the opening and closing speed are arranged close to the swivelling axis of the door. This results in a vague detection of said opening angle and opening and closing speed.

It is an object of the present invention to provide an automatic door for a domestic appliance, which may be manually opened and/or closed by the user, wherein the opening angle and/or the opening and closing speed of said automatic door are reliably detectable.

The object is achieved by the automatic door for a domestic appliance according to claim 1.

According to the present invention an automatic door for a domestic appliance, in particular an automatic oven door for a cooking oven, is provided, wherein:
the door comprises at least one door handle for manually opening and/or closing said door, and
the door comprises at least one switch element for automatically opening and/or closing said door.

The core of the present invention is the arrangement of the door handle at the automatic door. The user is additionally able to open and/or close the door manually.

In particular, the door comprises at least one door sensor for detecting the opening angle and/or the opening and closing speed of said door.

Additionally, the door sensor may be provided for detecting the presence and/or proximity of a user in front of the door.

Preferably, the at least one switch element for opening and/or closing the door is arranged within the door handle.

For example, the switch element for opening and/or closing the door is a touch sensor. Preferably, said touch sensor is arranged at the front side of the door handle.

Further, the door sensor may be arranged within the door handle and/or at the front side of said door handle. The arrangement of the door sensor within and/or at the front side of the door handle allows a big distance between said door sensor and the swivelling axis of the door.

In particular, the door handle is elongated and arranged horizontally or vertically in the front of the door. Preferably, the door handle extends parallel to a pivoting axis of the door. In particular, said door handle is spaced apart from the pivoting axis of the door.

For example, the switch element and the door sensor are arranged serially along the elongated door handle.

Preferably, the door sensor is arranged in the central portion of the door handle, while the switch element for opening the door and the switch element for closing the door are arranged in opposite lateral portions of said door handle. In general, the door sensor may be arranged in an arbitrary opposition within or at the door handle. Preferably, the switch elements for opening and closing the door are spaced apart from each other.

Further, the door may comprise at least one drive unit for automatically opening and/or closing said door, wherein preferably said drive unit is an electric motor.

Additionally, the door may comprise at least one door lock unit for locking said door in the closed state. In this case, the door can be automatically opened only, for example by touching a door opening sensor.

Moreover, the door comprises at least one control unit for controlling the drive unit and/or the door lock unit.

Preferably, the control unit is connected to the switch element, the door sensor and/or further sensors, so that signals from the switch element, the door sensor and/or further sensors are used for controlling the drive unit and/or the door lock unit.

Further, the door may comprise or correspond with at least one display element for indicating the state of the door and/or signals from the switch element, the door sensor and/or further sensors.

Additionally, the door may comprise or correspond with at least one device for indicating an activation of the automatic opening and/or closing of said door, preferably by an optical or acoustic signal.

In particular, the door comprises at least one delay circuit for delaying the automatic opening and/or closing of said door.

At last, the present invention relates to a domestic appliance, in particular a cooking oven, wherein the domestic appliance comprises at least one door mentioned above.

Novel and inventive features of the present invention are set forth in the appended claims.

The present invention will be described in further detail with reference to the drawing, in which

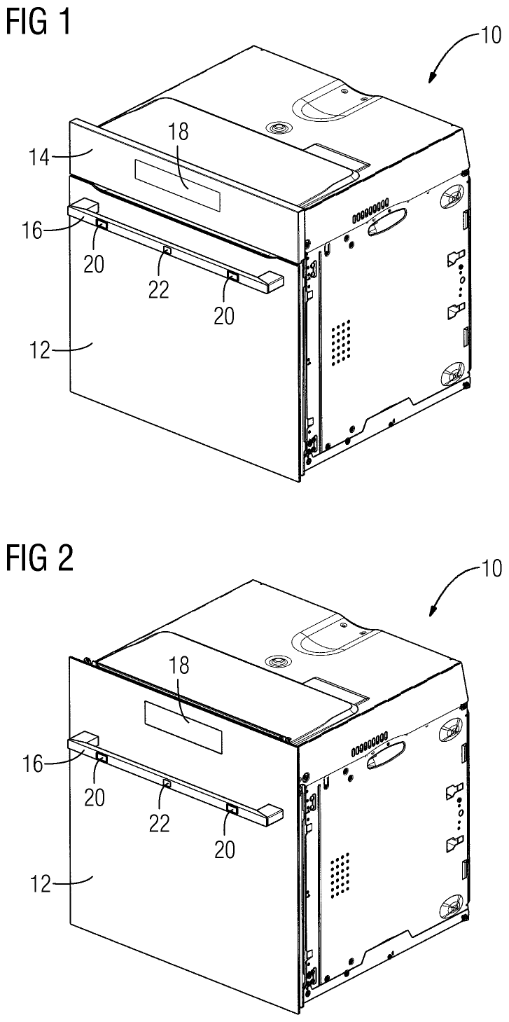

FIG. 1 illustrates a schematic perspective view of a cooking oven with an automatic oven door according to a first embodiment of the present invention,

FIG. 2 illustrates a schematic perspective view of the cooking oven with the automatic oven door according to a second embodiment of the present invention,

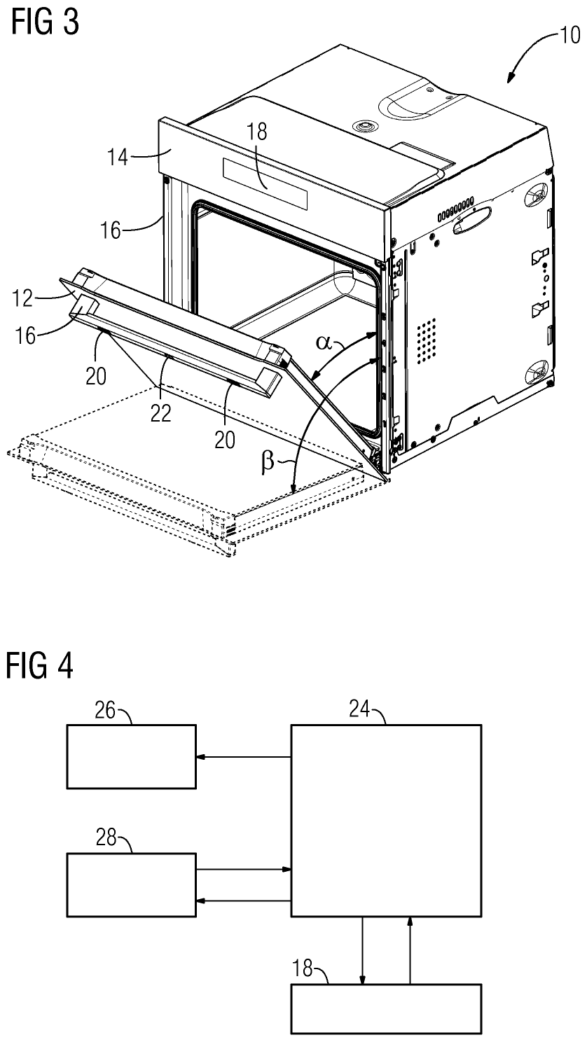

FIG. 3 illustrates a schematic perspective view of the cooking oven with the automatic oven door in an open state according to the first embodiment of the present invention, and

FIG. 4 illustrates a schematic circuit diagram of a control circuit for the automatic oven door according to the present invention.

FIG. 1 illustrates a schematic perspective view of a cooking oven 10 with an automatic oven door 12 according to a first embodiment of the present invention. In general, the present invention relates to a domestic appliance with an automatic door.

The oven door 12 is arranged at the front side of the cooking oven 10 and provided for opening and closing an oven cavity of said cooking oven 10. Further, a front panel 14 is arranged above the oven door 12. A display element 18 is integrated within said front panel 14.

A door handle 16 is attached at the front side of the oven door 12. The door handle 16 extends horizontally and is arranged in an upper portion of the oven door 12. The door handle 16 is provided for a manual opening and closing of the oven door 12.

The door handle 16 includes two touch sensors 20 and a door sensor 22. In this example, the touch sensors 20 and the door sensor 22 are arranged at the front side of the door handle 16. Alternatively, the touch sensors 20 and the door sensor 22 may be arranged at the rear side of the door handle 16. In general, the touch sensors 20 and the door sensor 22 may be arranged at arbitrary sides of the door handle 16. Preferably, the door handle 16 is elongated, so that the sensors 20 and 22 and further sensors may be arranged in series along said door handle 16.

In this example, the oven door 12 is a drop-down door, wherein a pivoting axis and the elongated door handle 16 of said oven door 12 extend horizontally. Alternatively, the oven door 12 may be a side-hung door, wherein the pivoting axis and the elongated door handle 16 of said oven door 12 extend vertically. In both cases, the door handle 16 may extend parallel to a pivoting axis of the oven door 12 and may be spaced apart from said pivoting axis.

When the touch sensor 20 is touched by the user, then a signal is output that said touch sensor 20 has been activated. Said signal may be an optical and/or acoustic signal. For example, the display element 18 may indicate that the touch sensor 20 has been activated. After a delay period, a drive unit 26 is activated and opens or closes automatically the oven door 12. However, the oven door 12 may be also opened and/or closed manually by the user. For example, the one of the touch sensors 20 may be provided for opening the oven door 12, while the other one of the touch sensors 20 may be provided for closing said oven door 12. Instead of the touch sensors 20, the door handle 16 may include arbitrary switch elements. Further, the door handle 16 may include only one switch element for opening and closing the oven door 12, so that the switch element is a dual function switch.

Furthermore, the door sensor 22 may be provided for detecting an opening angle α and/or an opening and a closing speed of the oven door 12. Further, the door sensor 22 may be provided for detecting an acceleration of the oven door 12. Moreover, the door sensor 22 may be provided for detecting a position of the oven door 12. Additionally, the door sensor 22 may be provided for detecting the presence of the user in front of the oven door 12.

In this example, the touch sensors 20 and the door sensor 22 are arranged serially along the elongated door handle 16, wherein the door sensor 22 is arranged in a central portion of said door handle 16, while the touch sensors 20 for opening and closing the oven door 12 are arranged in opposite lateral portions of said door handle 16. In general, the door sensor 22 may be arranged in an arbitrary position at or within the door handle 16. Preferably, the touch sensors 20 for opening and closing the oven door 12 are spaced apart from each other.

In particular, the sensors 20 and 22 are selected from touch-sensitive sensors, proximity-sensitive sensors, pressure-sensitive sensors, angle-recognition sensors, movement sensors, acoustic sensors, optical sensors, capacitive sensors, inductive sensors, acceleration sensors, gyro sensors or a combination of said sensors.

FIG. 2 illustrates a schematic perspective view of the cooking oven 10 with the automatic oven door 12 according to a second embodiment of the present invention.

The oven door 12 is arranged at the front side of the cooking oven 10 and provided for opening and closing the oven cavity of said cooking oven 10. In this embodiment, the oven door 12 covers completely the front side of the cooking oven 10. The front panel 14 lacks in this embodiment. The display element 18 is integrated within the oven door 12.

The door handle 16 is attached at the front side of the oven door 12 and beneath the display element 18. The door handle 16 extends horizontally. The door handle 16 is provided for a manual opening and closing of the oven door 12. The door handle 16 includes at least one touch sensor 20 and the door sensor 22 with the same functions as in the first embodiment shown in FIG. 1. For example, one touch sensor 20 is provided for opening the oven door 12, while a further touch sensor 20 is provided for closing said oven door 12. Alternatively, one single dual function switch may be provided for opening and closing the oven door 12. Moreover, the oven door 12 may be also opened and closed manually by the user.

Also in this example, the oven door 12 is a drop-down door, wherein the pivoting axis and the elongated door handle 16 of said oven door 12 extend horizontally. Alternatively, the oven door 12 may be a side-hung door, wherein the pivoting axis and the elongated door handle 16 of said oven door 12 extend vertically. In both cases, the door handle 16 may extend parallel to the pivoting axis of the oven door 12 and may be spaced apart from said pivoting axis.

FIG. 3 illustrates a schematic perspective view of the cooking oven 10 with the automatic oven door 12 in an open state according to the first embodiment of the present invention.

In FIG. 3 the oven door 12 is opened at an opening angle α. Further, the oven door 12 at a maximum opening angle β is shown by dotted lines in FIG. 3.

FIG. 4 illustrates a schematic circuit diagram of a control circuit for the automatic oven door 12 according to the present invention.

The control circuit comprises a control unit 24 and the display unit 18. The control unit 24 and the display unit 18 are bidirectionally connected to each other. Further, the control unit 24 is unidirectionally connected to the drive unit 26. The drive unit 26 is provided for the automatic opening and closing of the oven door 12. The drive unit 26 is directly controlled by the control unit 24. Preferably, the drive unit 26 is an electric motor. Moreover, the control unit 24 is bidirectionally connected to a door lock unit 28. The door lock unit 28 is provided for locking the oven door 12. Additionally, the control unit 24 may be connected to the touch sensors 20 and to the door sensors 22, so that the control unit 24 can receive signals from the touch sensors 20 and door sensors 22. Thus, the control unit 24 can activate the drive unit 26 in dependence of the signals from the touch sensors 20, the door sensor 22 and further sensors.

The door lock unit 28 allows a locked state of the oven door 12, in which the oven door 12 cannot be manually opened by the user.

In one embodiment of the present invention, it is only possible to open automatically the oven door 12, for example by the touch sensor 20, while said oven door 12 is manually closed by pushing the door handle 16.

For opening the oven door 12 manually as well, a door closing force has to be generated. For example, said door closing force may be generated by door hinges. Thus, a stronger motor for automatically opening the oven door 12 is required in order to overcome the door closing force of the door hinges, wherein the door lock unit 28 in not necessary. If the door hinges do not generate any door closing force or said door hinges generate a very small door closing force, then the door lock unit 28 is required and the oven door can be opened automatically only after releasing said door lock unit 28. Since there is no door closing force from the door hinges, less power is required for opening the oven door, so that a smaller motor would be sufficient.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 cooking oven
12 oven door
14 front panel
16 door handle
18 display element
20 touch sensor
22 door sensor
24 control unit
26 drive unit
28 door lock unit
α opening angle
β maximum opening angle

1. An automatic door for a domestic appliance, comprising:
at least one door handle for manually opening and/or closing said door, and
at least one switch element for automatically opening and/or closing said door.

2. The door according to claim 1, wherein further comprising at least one door sensor for detecting an opening angle and/or an opening and closing speed of said door.

3. The door according to claim 2, wherein the door sensor is provided for detecting a presence and/or proximity of a user in front of the door.

4. The door according to claim 1, wherein the at least one switch element for automatically opening and/or closing the door is arranged within the door handle.

5. The door according to claim 1, wherein the at least one switch element for automatically opening and/or closing the door is a touch sensor arranged at a front side of the door handle.

6. The door according to claim 2, wherein the door sensor is arranged within the door handle.

7. The door according to claim 1, wherein the door handle is elongated and arranged horizontally or vertically in a front of the door, extending parallel to a pivoting axis of the door.

8. The door according to claim 7, wherein the at least one switch element comprising a first switch element for opening the door and a second switch element for closing the door, the first and second switch elements and a door sensor for detecting an opening angle and/or an opening and closing speed of the door being arranged serially along the elongated door handle, wherein the door sensor is arranged in a central portion of the door handle, while the first switch element for opening the door and the second switch element for closing the door are arranged in opposite lateral portions of said door handle.

9. The door according to claim 1, further comprising at least one drive unit for automatically opening and/or closing said door, said drive unit comprising an electric motor.

10. The door according to claim 1, further comprising at least one door lock unit for locking said door in a closed state so that the door can be opened neither manually nor automatically.

11. The door according to claim 1, further comprising an electric motor for automatically opening and/or closing the door and a door lock unit for locking the door in a closed state so that the door can be opened neither manually nor automatically, and at least one control unit for controlling the drive unit and/or the door lock unit, wherein the control unit is connected to the at least one switch element, to a door sensor for detecting an opening angle and/or an opening and closing speed of said door, and/or to further sensors, so that signals from the at least one switch element, the door sensor and/or the further sensors are used for controlling the drive unit and/or the door lock unit.

12. The door according to claim 1, further comprising or being associated with at least one display element for indicating a state of the door and/or signals from the at least one switch element, a door sensor that detects an opening angle and/or an opening and closing speed of the door, and/or further sensors.

13. The door according to claim 1, further comprising or being associated with at least one device for indicating an activation of the automatic opening and/or closing of said door by an optical or acoustic signal.

14. The door according to claim 1, further comprising at least one delay circuit for delaying the automatic opening and/or closing of said door.

15. A cooking oven comprising the door according to claim 1.

16. A cooking oven comprising an oven cavity and a door configured to open and close the oven cavity by pivoting along a pivot axis of the door, a door handle on a front face of the door located remote from the pivot axis, a door sensor on the door handle adapted to detect an opening angle and/or a speed of opening or of closing said door, a first switch element on the door handle adapted to be actuated by a user to automatically open and/or close said door, an electric motor adapted to pivotally drive said door between a closed position and a maximum open position thereof, and a controller operatively coupled to each of the door sensor, the first switch element and the motor, the controller being adapted to operate said electric motor in order to automatically open the door by pivotally driving said door toward said maximum open position or to automatically close the door by pivotally driving said door toward said closed position in response to said first switch being actuated by the user, the door further being operable via the user grasping the handle to manually pivot the door toward either of the maximum open or closed positions independent of the electric motor.

17. The cooking oven according to claim 16, further comprising a second switch element on the door handle that is operatively coupled to the controller, said first switch element comprising a first touch sensor configured to send an ‘open’ signal to the controller upon user actuation of the first touch sensor, said second switch element comprising a second touch sensor configured to send a ‘close’ signal to the controller upon user actuation of the second touch sensor, the controller being adapted to operate said motor to pivotally drive the door toward said maximum open position on receiving the ‘open’ signal and to pivotally drive the door toward said closed position on receiving the ‘close’ signal, and a door lock unit operatively coupled to said controller, the door lock unit being adapted to lock the door in the closed position so that the door cannot be manually opened when the door lock unit is engaged, but can be opened automatically by actuating said first touch sensor when the door lock unit is engaged.

18. The cooking oven according to claim 17, further comprising a display unit operatively coupled to the controller and adapted to display information pertaining to a state of the door and in response to actuation of either of said first or second switch elements.

19. The cooking oven according to claim 17, said door handle being an elongated door handle extending parallel to said pivot axis, said first and second switch elements being arranged serially with and disposed on opposite sides of said door sensor along the elongated door handle.

20. The cooking oven according to claim 17, said controller being configured to operate said electric motor in response to either the ‘open’ or ‘close’ signal only after a delay period from receiving the respective signal.
